(19) United States
(12) Patent Application Publication
(10) Pub. No.: US 2011/0113620 A1
(43) Pub. Date: May 19, 2011

(54) Manufacturing Method of Magnetic Head Slider

(75) Inventors: Shinji Sasaki, Yokohama (JP); Hiroyuki Kojima, Yokohama (JP); Nobuhiko Fukuoka, Hiratsuka (JP); Kenji Furusawa, Hiratsuka (JP)

(73) Assignee: HITACHI, LTD., Tokyo (JP)

(21) Appl. No.: 12/948,348

(22) Filed: Nov. 17, 2010

(30) Foreign Application Priority Data
Nov. 18, 2009 (JP) 2009-262450

(51) Int. Cl. G11B 5/127

(52) U.S. Cl. 29/603.07

(57) ABSTRACT

A conventional lapping process of executing element size control and surface roughness reduction at the same time is divided in the present invention into a lapping process for element size control and a lapping step for surface roughness reduction. In the lapping process for surface roughness reduction, a surface of a ceramic substrate portion is used as a stopper for limiting cut-in of abrasive grains to realize surface roughness reduction while maintaining productivity.

### INCORPORATION BY REFERENCE

The present application claims priority from Japanese application JP 2009-262450 filed on Nov. 18, 2009, the content of which is hereby incorporated by reference into this application.

### BACKGROUND OF THE INVENTION

The present invention relates to a manufacturing method for a magnetic head slider equipped with a reader element and a writer element.

A recent increase in an amount of information to be processed with a magnetic read/write apparatus has made a rapid progress in high recording density. Under this circumstance, a high sensitivity and high output magnetic head is required. In order to meet this requirement, many efforts have been made to shorten the distance between a magnetic disc and a reader element and writer element of a magnetic head. A distance between the magnetic head and the magnetic disc includes: a thickness of an over coat formed on the surfaces of the magnetic head and magnetic disc for corrosion resistance and abrasion resistance; and a clearance avoiding likelihood contact due to a warp and irregularity of a magnetic disc and an irregularity of the head surface. For the former case, it is necessary that the over coat has a thickness sufficient to some extent to protect the surfaces of the magnetic head and magnetic disc. For the latter case, the clearance is able to be reduced by smoothing roughness of a head air bearing surface (ABS).

Lapping techniques have been improved heretofore in order to smooth the roughness of the head ABS. As illustrated in JP-A-2002-231452, a lapping process is divided into several processes, and fixed grain lapping is performed at a finishing lapping process by fixing abrasive grains to a lapping plate, to thereby reduce scratches. Further, the abrasive grains are made fine to reduce the roughness of a lapping plane.

### SUMMARY OF THE INVENTION

As disclosed in JP-A-2002-331452, using fine abrasive grains has the effect of reducing the roughness of the lapping plane to some extent, although some disadvantages occur. One of the disadvantages is a considerable reduction in lapping rate. Another manifested problem is that since the abrasive grains are fine, the embedded abrasive grains are likely to be dropped off and the dropped-off abrasive grains may cause generation of scratches.

The scratch problem may be suppressed by preliminarily lapping the lapping plate to remove beforehand abrasive grains likely to be dropped off. However, as apparent from an experiment example illustrated in FIG. 1, i.e., from a relation between the lapping rate of ABS and the lapping surface roughness, the problem associated with the fine abrasive grain diameter has a contradiction that the surface roughness does not reduce unless the lapping rate is lowered by making the abrasive grains small.

As also apparent from FIG. 1, even at a lapping rate of almost near to zero, the lapping surface roughness has a definite value and it is very difficult to smooth more than the definite value.

As described above, even under the contradictory relation between the lapping rate and the lapping surface roughness, it is required to lap the ABS of a magnetic head to a desired shape in as short time as possible.

Since the lapping process for magnetic heads functions also as a size control of the magnetic read/write element, a lowered process time prolongs a time taken to obtain a target processing or lapping amount, resulting in a lowered productivity. In order to avoid this, the lapping process is separated into a size control process and a surface roughness reducing process. The size control lapping process is executed at high speed until 1 to 5 nm remained to a target processing amount, whereas the roughness reducing process is executed at a lapping rate reduced to the extent that the both the lapping surface roughness and the lapping rate are satisfied.

In order to settle the above-described issue of the present invention, even in the surface roughness reducing process, the element portion is made in contact with the abrasive grains of the lapping plane to lap the element portion surface. Namely, the magnetic head to which the size controlling process was completed is subjected to a heating process to release a processing strain remained in the element and allow the writer element and reader element to swell. A specific heating method is preferably a method of uniformly heating a whole work, for example, by using an oven. A magnetic head is placed in an oven set at a temperature of 100° C. to 200° C. and heated for 10 minutes or longer to cause the element surface to swell by 1 to 5 nm.

After this heating process, the element surface protruding beyond the ceramic substrate by several nm is made in contact with the abrasive grains on the lapping plate to progress the lapping process even during the surface roughness process. In this case, the abrasive grains on the lapping plate apply a small surface pressure relative to the ceramic substrate and will not cut into the ceramic substrate, so that the ceramic substrate will not be worked. However, in a softer element region, the cut process of the abrasive grains into the element surface progresses. Since the abrasive grains will not cut into the ceramic region, blade edges of the abrasive grains will not fed further in a depth direction.

The surface roughness reducing process operates only to remove the element region surface protruding beyond the ceramic substrate surface. The abrasive grains which were not fed pass along the element surface to remove convex portions on the element surface without forming new concave portions. It is therefore possible to reduce the surface roughness of the whole ABS. In addition, a recess is hardly formed between the ceramic substrate portion and element portion.

Another method of settling the above-described issue is a method of executing the surface roughness reducing process by slanting the lapping plane by an extremely slight angle. Namely, a solid film having a thickness of 50 nm to several hundred nm is formed in a partial area of ABS at a position spaced apart by 500 μm or more from the element portion of the magnetic head after the size control process. In this state, the surface roughness reducing lapping process is executed to allow the lapping plate surface to be inclined by 0.006 degree to 0.02 degree because the solid film serves as a crosstie. Thus the lapping plate surface contacts the solid film and element portion surface, so that the element portion surface is able to be lapped while a lapping rate is retained.

After the element region is lapped to a depth of 2 to 4 nm at the position of the writer element in the element region, the lapping plate surface contacts the edge of the ceramic substrate so that the lapping process is stopped. Similar to the method described previously, with this method, the abrasive grains which were not fed pass along the element portion surface to remove convex portions on the element portion surface without forming new concave portions. It is therefore possible to reduce a surface roughness.

It is also possible to control the recess between the element portion and the ceramic substrate portion and the recess between the writer and reader in the element region.

According to the present invention, as compared to a general magnetic head manufacturing method using coarse lapping and finishing lapping, it is possible to improve further the roughness of the surface of the magnetic head facing the magnetic disc. It is therefore possible to realize a magnetic head slider applicable to a magnetic disc having a large storage capacity.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram for experimentally explaining a relation between lapping rate and lapping surface roughness.

FIG. 2 is a diagram for explaining a relation between lapping rate and lapping surface roughness obtained by experiments.

FIG. 3 is diagram for explaining a relation between lapping rate, lapping process time and lapping surface roughness obtained by simulation, particularly a relation at lapping rate near at zero.

FIG. 4 is a flow chart illustrating magnetic head working processes according to a first embodiment of the present invention.

FIG. 5 illustrates time sequential cross sectional views of a magnetic head slider in a series of processes (a)˜(d) from an element size control lapping process 113, an element heating process 114, and to a surface roughness reducing lapping process 115 in FIG. 4.

FIG. 6 is a diagram for illustrating a relation between average abrasive grain diameter and the lapping rate of a lapping plate.

FIG. 7 is a diagram illustrating a relation between abrasive grain density on a lapping plate and the lapping surface roughness of a magnetic head slider after lapping.

FIG. 8 is a diagram illustrating a change in an element portion air bearing upper surface during the heating process according to the first embodiment.

FIG. 9 is a diagram for explaining a relation between lapping process time, surface roughness and recess amount during the surface roughness reducing lapping process of the first embodiment.

FIG. 10 is a diagram for explaining the outline of the surface shape of a magnetic head slider after the surface roughness reducing lapping process of the first embodiment.

FIG. 11 is a flow chart illustrating magnetic head working processes according to a second embodiment of the present invention.

FIG. 12 illustrates time sequential cross sectional views of a magnetic head slider in a series of processes (a)˜(d) from a hard film forming process 214, a surface roughness reducing lapping process 215, to a hard film removing process 216 in FIG. 11.

FIG. 13 is a schematic cross sectional view illustrating a magnetic head slider after the hard film removing process of the first embodiment.

FIG. 14 is a diagram for explaining a relation between lapping time and the surface roughness of the second embodiment.

### DETAILED DESCRIPTION OF THE EMBODIMENTS

Prior to describing specific embodiments, description will be made first on the results of a relation between lapping rate and lapping surface roughness calculated by using the Monte Carlo method. The lapping surface roughness was calculated by using abrasive grain density, lapping rate and others as parameters and at a time when the abrasive grains have passed through with cutting the work surface.

It was assumed that the blade edge of each abrasive grain is of a semisphere shape, and a surface region contacting the blade edge is removed in the blade edge shape. Positions where the abrasive grains pass were determined randomly by using random numbers, heights were set so as to obtain a predetermined variation, and an average position of the blade edges of the abrasive grains was changed so as to obtain a predetermined lapping rate.

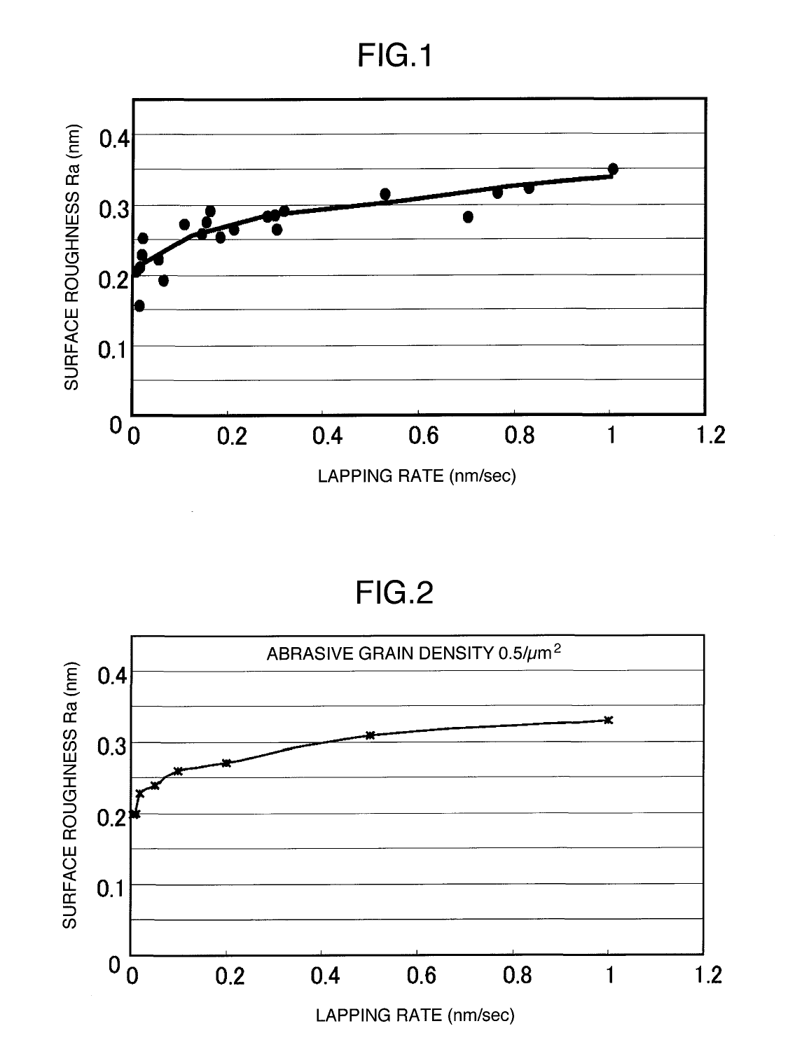

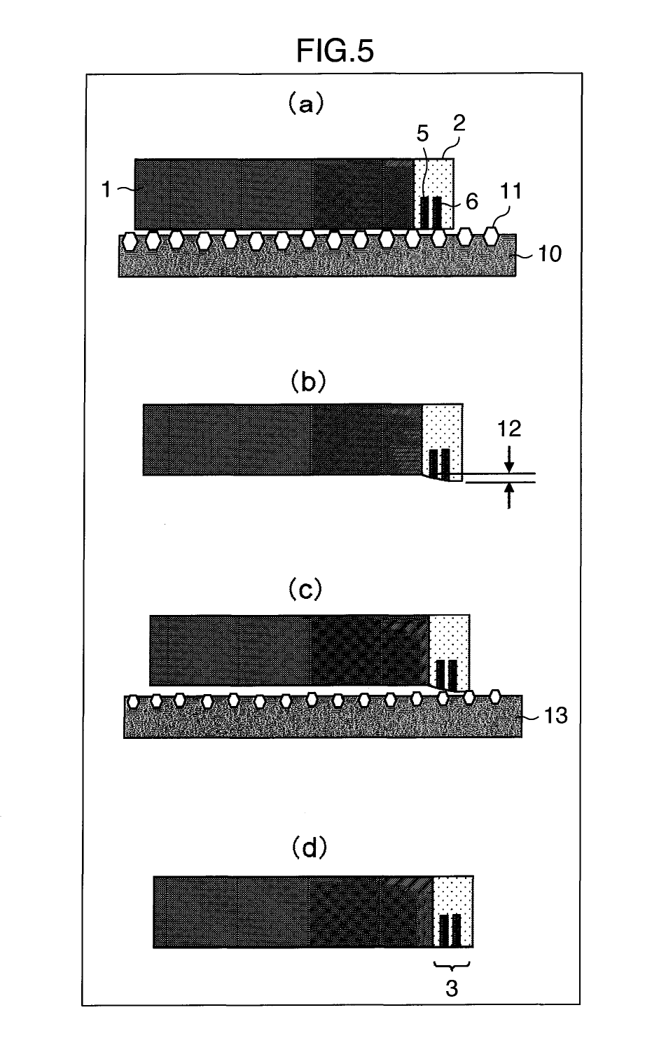

FIG. 2 illustrates simulation results of a relation between the lapping rate and the lapping surface roughness at an abrasive grain density of 0.5 grain/μm². As clearly seen from FIG. 5, it is understood that the lapping surface roughness reduces as the lapping rate lowers. This macroscopic tendency reproduces the experiment results illustrated in FIG. 1 fairly well.

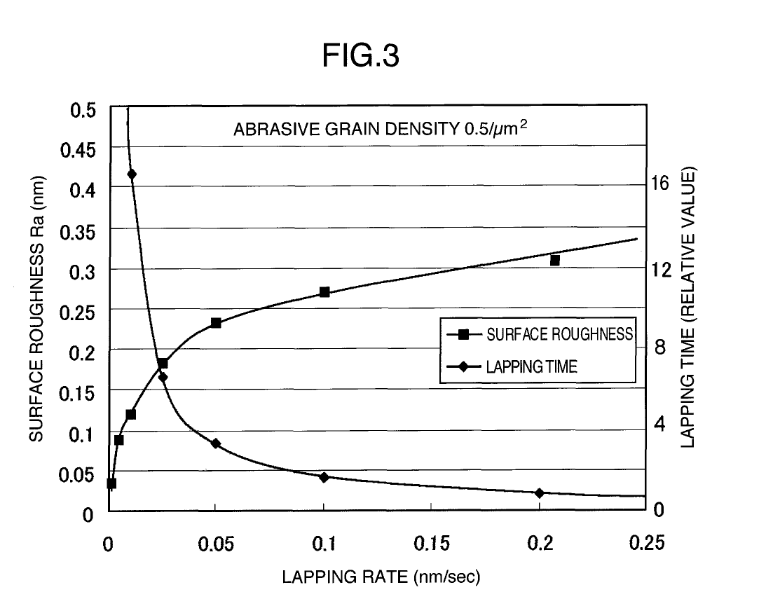

The relation when the lapping rate comes to zero as near as possible was calculated more precisely. The calculation results are illustrated in FIG. 3 at an abrasive grain density of 0.5 grain/μm². It is apparent from FIG. 3 that as the lapping rate comes near to zero, the lapping surface roughness comes to zero as near as possible. This phenomenon is based upon a mechanism that, since the blade edges of the abrasive grains are not fed in the depth direction, the passed abrasive grains remove only concave portions without forming new hollows (scratches) while the abrasive grains pass through the lapping surface.

In the experiment example illustrated in FIG. 1, the surface roughness has a constant value (the surface value is 0.15 to 0.25 nm in FIG. 1) even if the lapping rate reaches near zero. The calculation results illustrated in FIG. 3 clearly indicate that by setting a feed rate of the blade edges of the abrasive grains in the depth direction to zero (setting a lapping rate to zero), it becomes possible to set the lapping surface roughness near to its minimum.

On the basis of the above-described knowledge, description will be made on lapping of the air bearing surface of a magnetic head according to the first embodiment.

As described earlier, it is desirable from the viewpoint of productivity that, in the magnetic head manufacturing process, a lapping process to control the magnetic head size is executed at high speed, whereas a lapping process to reduce the surface roughness is executed at a lapping rate equal to or faster than a predetermined value. The following method was used as a method of lowering the lapping rate of the surface roughness reducing lapping process.

The air bearing surface of a magnetic head to be worked is constituted of a ceramic substrate portion and an element portion made of alumina and magnetic material, and both the portions are worked at the same time. Since the ceramic substrate portion has a higher hardness than that of the element portion, the lapping rate is determined by a cut amount of abrasive grains into the ceramic surface. This means that if the abrasive grains are unable to cut into the ceramic surface, the feed of the blade edges in the depth direction is stopped.

The conditions of eliminating the cut-in of the ceramic surface are able to be realized microscopically by setting a load upon each abrasive grain lower than a threshold value at which the cut-in (surface plastic deformation) starts, and macroscopically by lowering a surface pressure between the lapping plate and the work or increasing the density of the abrasive grains acting upon a work.

In a practical case of usual lapping, the lapping rate of the lapping plate lowers as a use time lapses. This is because the heights of the abrasive grains on the lapping plate become gradually uniform and the number of abrasive grains associated with lapping increases, so that a load upon each abrasive grain lowers and the cut-in lowers. The lapping plate in this state has no practical value for the size control because of its lower productivity, although it may be reused for the surface roughness reduction.

Although the lapping rate can be lowered by the above-described method, it is impossible to perform a desired work if the lapping plate with the lowered lapping rate is used for a magnetic head surface work after the size control work. The reason is as follows. In a conventional lapping process having a certain degree of lapping rate, there is a surface pressure allowing the abrasive grains to cut into the ceramic surface of the substrate portion, and the cut-in of abrasive grains becomes larger in the softer element portion. This may result in forming an average recess of several nm on the element portion relative to the average recess on the substrate portion. Even if the lapping plate unable to obtain a lapping rate sufficient for the ceramic portion surface is used for lapping the element portion surface, the blade edges of abrasive grains will not reach the element portion and the surface thereof will not be lapped. In other words, this will not lead to further improvement of the lapping surface roughness.

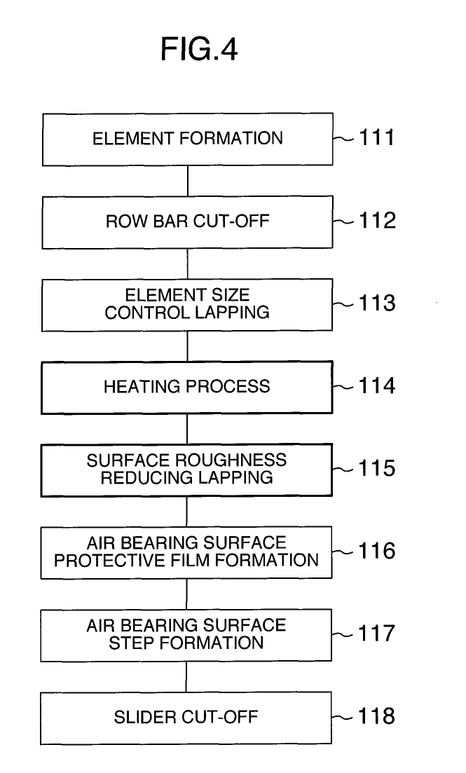

FIG. 4 is a flow chart illustrating lapping processes of a magnetic head slider according to the first embodiment. After read/write elements of each magnetic head are formed on a ceramic substrate (a read/write element forming process 111), a wafer is cut off into rectangular pieces (row bars) each having 40 to 60 consecutive magnetic head sliders (a row bar cut-off process 112), and the cut-off surface is used as the air bearing surface to be smoothed by lapping. In this case, the magnetic read/write elements are exposed on the air bearing surface, and two processes for developing predetermined magnetic characteristics are executed including an element size control lapping process 113 of lapping the cut-off surface by a predetermined amount, and a surface roughness reducing lapping process 115 of smoothing the cut-off surface.

Next, in order to protect the surface of the air bearing surface which was lapped flat, a generally well-known hard carbon thin film is formed by about 3 nm (an air bearing surface protective film forming process 116), and thereafter an air bearing surface step forming process 117 is executed by dry etching to stabilize a floating amount of the magnetic disc slider floating above a magnetic disc. Lastly, each row bar is cut off into individual magnetic head sliders (a magnetic head slider cut-off process 118), and thereafter a magnetic recording apparatus is completed by combining the magnetic head slider with a magnetic disc, a driver and the like.

A characteristic process of the present invention is an element heating process 114 not used by conventional manufacture processes and provided between the element size control lapping process 113 and the surface roughness reducing lapping process 115. Detailed description will now be made on the role, operation, effects and others of the element heating process 114, with reference to the accompanying drawings.

FIG. 5 illustrates time sequential cross sectional views of a magnetic head slider in a series of processes (a)˜(d) including the element size control lapping process 113, the element heating process 114, and the surface roughness reducing lapping process 115. In FIG. 5, (a) illustrates the element size control lapping process 113. A reference numeral 1 represents the ceramic substrate portion of the magnetic head slider, and a reference numeral 2 represents the magnetic head element portion including a writer element 5 and a reader element 6. This process is a lapping process to arrange each row bar as cut off from a wafer to an element size suitable for read/write by using lapping techniques. More specifically, for example, a length of the reader element in the depth direction from the lapping surface as the row bar was cut off is several μm, however, this length is required eventually to be 100 nm or shorter (in this embodiment, the reader element size is 80 nm).

The element size control lapping process 113 executes a multi stage lapping process including coarse lapping and precise lapping, in order to satisfy both the productivity and size precision because of the large lapping amount of the element. In this embodiment, the coarse lapping executes a free abrasive lapping while abrasive grains 11 having an average grain diameter of 250 nm are supplied as slurry to the lapping plate 10. When the size of the reader element from the lapping plane in the depth direction becomes about 500 nm, the next step of the precise lapping is executed. Specifically, by using the lapping plate 10 embedding abrasive grains having an average grain diameter of 100 nm in the surface layer thereof, applying a lapping surface pressure of 0.2 MPa or larger between the lapping plate and the row bar, and at a practical production lapping rate, e.g., at 0.1 nm/sec, the lapping was executed until to an element size of 85 nm, leaving 5 nm to be removed to a final target element size, 80 nm, by the heating process and surface roughness reducing lapping process to be described later (refer to FIG. 5, (a)). In this case, an average surface roughness Ra of the read/write element region surface in the row bar state is about 0.4 nm which is a value far from a target surface roughness of the present invention.

FIG. 5, (b) is a cross sectional view of the magnetic head slider for explaining the heating process 114 illustrated in FIG. 4. The objective of the heating process is to release lapping strain applied to the element surface (lapping plane) during the element size control lapping process 113 and to protrude the element surface from the lapping plane. Specifically, the whole row bar is heated in, e.g., an oven, at 100° C. or higher, 200° C. or lower for 100 minutes or longer to release the lapping strain.

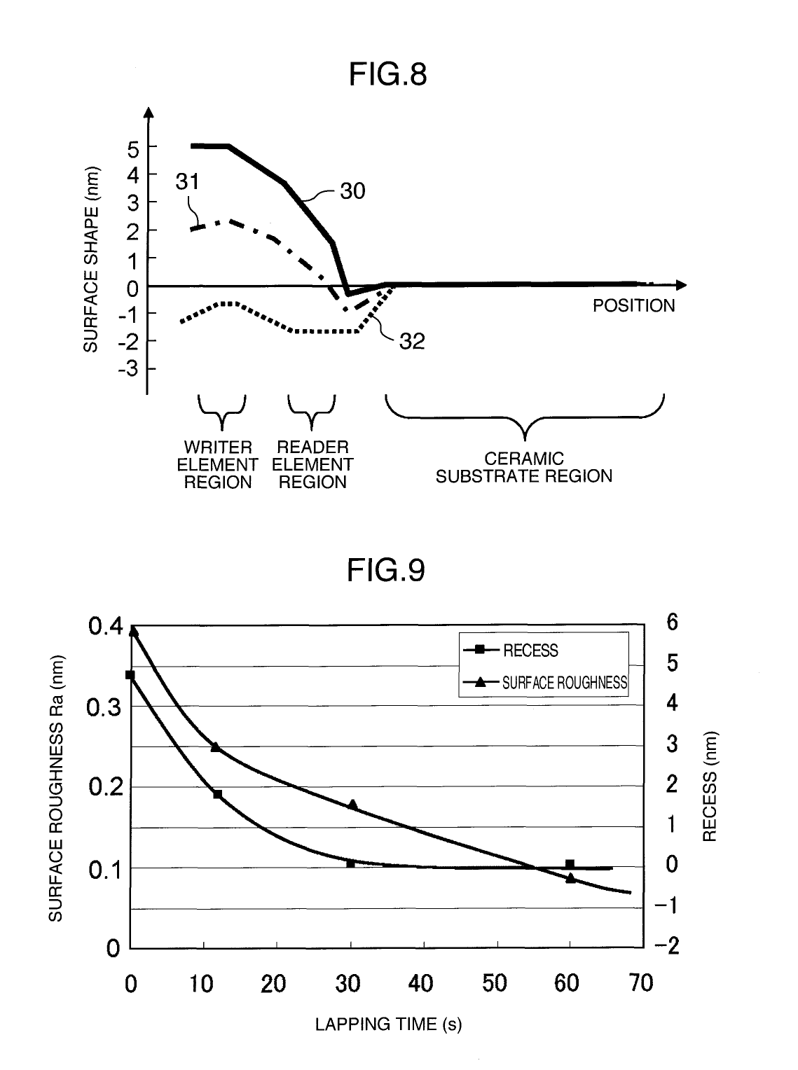

In the outline shape of the magnetic head slider after the heating process illustrated in FIG. 5, (b), a reference numeral 12 represents a protruded portion caused by heating. The details of the protruded portion are illustrated in FIG. 8 and indicated by the measurement results of the surface shape of the magnetic head element portion with an atomic force microscope. The abscissa represents a position of the element portion surface as measured from the element portion surface edge (right edge in FIG. 5, (b)) toward the ceramic substrate portion 1, and the ordinate represents a height of the element region in terms of the surface position of the ceramic substrate portion as a reference.

The surface shape of the element portion before the heating process (at the completion stage of the element size control lapping process 113, refer to FIG. 5, (a)) is represented by a line 32 indicating a shape depressed lower than the surface (lapping surface) of the ceramic substrate portion 1. The surface shape of the element portion after heating at 150° C. for 20 minutes is represented by a line 31, and the surface shape of the element portion after heating at 200° C. for 20 minutes is represented by a line 30. As illustrated, the protrusion amount becomes larger at the position nearer to the element portion edge. Specifically, it is seen that the protrusion amounts under the above-described heating conditions are 2 nm and 5 nm, respectively, at the position near the write element portion 6.

Next, the surface roughness reducing lapping process 115 as the objective of the present invention is executed (refer to FIG. 4). In FIG. 5, (c) illustrates this process which removes the element surface portion only by the protruded amount.

As different from the lapping plate used by the element size control lapping process 113, it is important to use a lapping plate 13 having a very low lapping rate relative to the ceramic substrate portion 1. In this embodiment, the lapping plate was adjusted to have a lapping rate of 0.001 nm/sec or slower at a lapping surface pressure of 0.1 MPa. An average height of the abrasive grains embedded in the lapping plate is 20 nm or lower, and an average abrasive grain density is 0.4 grain/μm² or higher.

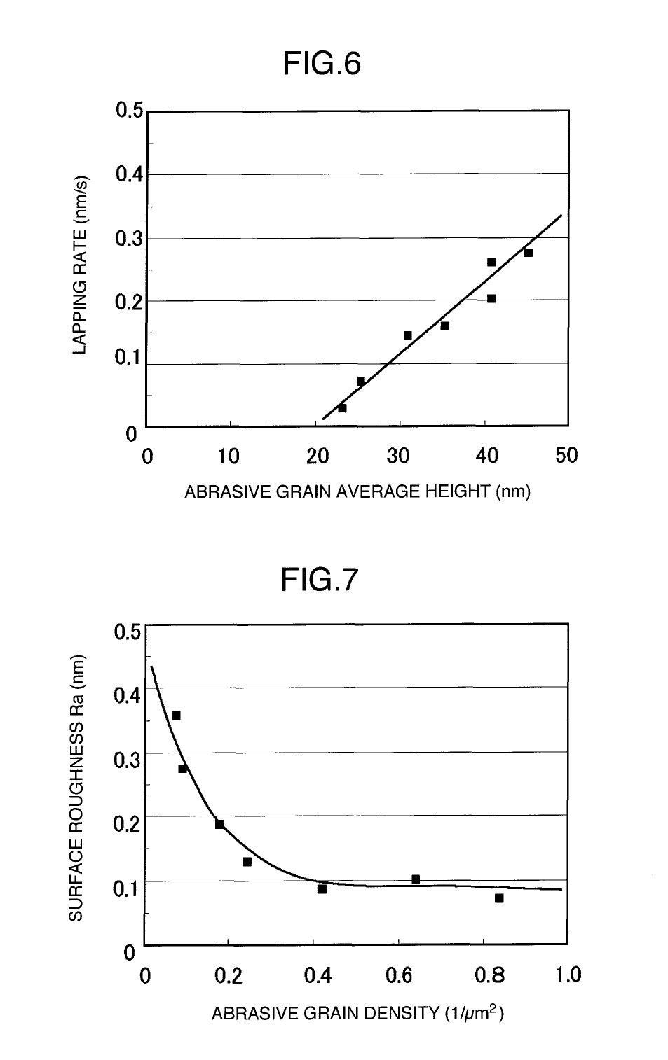

FIG. 6 illustrates a relationship between the average abrasive height and the lapping rate of the ceramic material as the substrate material, and FIG. 7 illustrates the average abrasive density and the surface roughness. At the average abrasive grain height of 20 nm or lower, the lapping rate lowers abruptly and the lapping rate of the ceramic material lowers almost to zero. It is apparent from the experimental results that at the abrasive grain density of 0.4 grain/μm² or lower, the surface roughness is degraded.

The average abrasive grain height is defined as in the following. An area of 5 μm square at each of 10 arbitrary positions (preferably, 24 positions at a 45-degree interval on inner, middle and outer circumferences) is measured with an atomic force microscope, 10 heights from the highest of the embedded abrasive grains at each measuring point are selected, and the average height of abrasive grains selected in all the areas is calculated. The abrasive grain density is measured on the lapping plate surface by an atomic force microscope (AFM), and the grain density of 0.4 grain/μm² means that 10 protrusions corresponding to the abrasive grains were observed in an area of 5 μm square.

The lapping plate has a lapping rate of 0.001 nm/sec or slower relative to the ceramic substrate portion of the magnetic head slider as described above. However, this lapping plate has a lapping ability with regard to the element portions 2, 5 and 6 having a far smaller hardness than that of the ceramic substrate portion 1. As the row bar having the element portion protruded by the heating process 114 is lapped with this lapping plate, the protruded element portion 12 is lapped being contacted with the abrasive grains of the lapping plate. It is therefore possible to planarize the element portion (refer to FIG. 5, (d)).

In this state described above, FIG. 9 illustrates a relationship between the surface roughness and the recess amount of the writer element portion 6 in terms of the substrate 1 surface as a reference. The abscissa represents the lapping time, the left ordinate represents the surface roughness indicated by solid triangles, and the right ordinate represents the recess amount indicated by solid squares. It is seen that the recess amount of the writer element portion 6 before the surface roughness reducing lapping process 115 corresponds to a portion protruded by about 5 nm, while this recess amount gradually reduces as the lapping starts, and the recess amount becomes almost zero after 30 seconds after the lapping start. Moreover, the element portion surface roughness was reduced and a surface roughness Ra of 0.1 nm or smaller was realized after 60 seconds.

The cut-in of abrasive grains relative to the element portion is 5 nm at the maximum at the start of lapping. However, since the blade edges of abrasive grains are not able to be cut into the ceramic substrate portion 1, the blade edges move to the element portion at the same position as the surface of the ceramic substrate portion 1. Since the blade edges of abrasive grains will not cut into the element portion deeper than the ceramic substrate portion surface but remove the protruded portions protruding beyond the ceramic substrate portion, the surface roughness is reduced.

Lapping continues for about 30 seconds also after the protruded portion of 5 nm is removed by lapping. In this state, the lapping rate is 0.001 nm/sec being restricted by the ceramic substrate portion. The size change by lapping during the last half of 30 seconds is 0.03 nm or smaller and is negligible. The element size reaches the target size of 80 nm after the lapping.

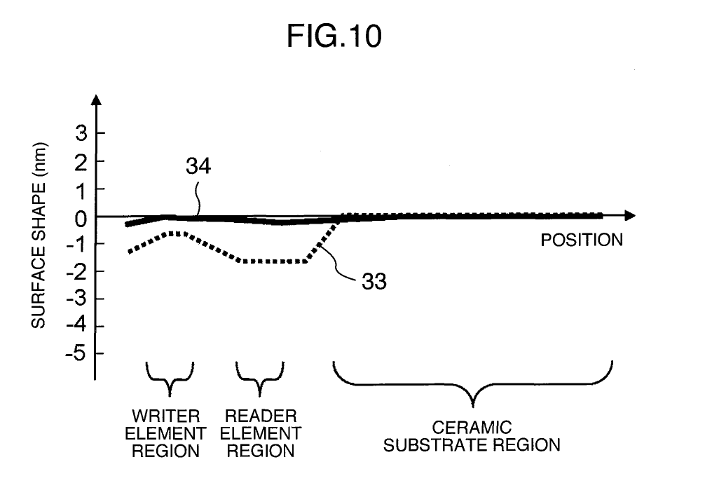

FIG. 10 illustrates an outline surface shape of the magnetic head slider after the surface roughness reducing lapping process 115. A line 33 (corresponding to the line 32 in FIG. 8) represents the surface shape of the magnetic head slider at the stage when the element size control lapping process 113 is completed, and a line 34 represents the surface shape of the magnetic head slider after the surface roughness reducing lapping process 115 improving the surface shape remarkably. It was possible to realize a very flat element portion surface having a recess amount of +/−0.1 nm relative to the ceramic substrate portion 1.

The processes after the surface roughness reducing lapping process 115 are also illustrated in FIG. 4 to complete a magnetic head slider. These processes, including the air bearing surface protective film forming process 116 of forming a protective film on the lapping surface, the air bearing surface step forming process 117 of regulating the floating characteristics of the magnetic head slider; the slide cut-off process 118 for separating a row bar into individual magnetic head sliders, and other processes.

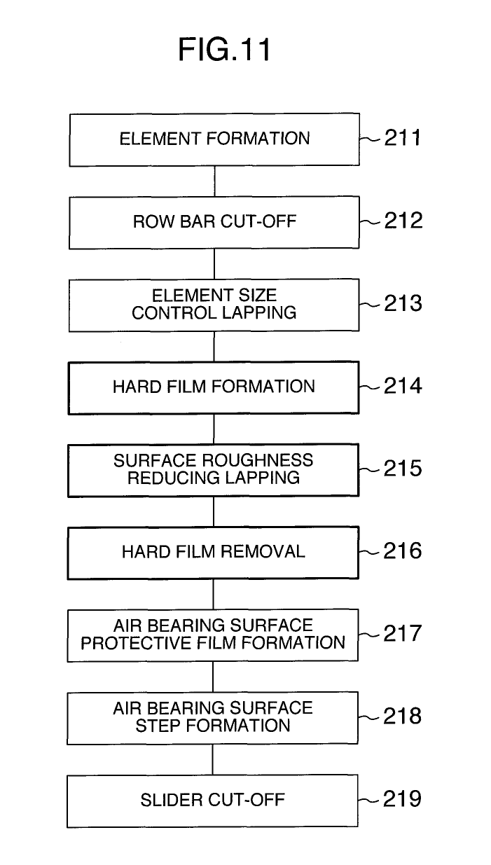

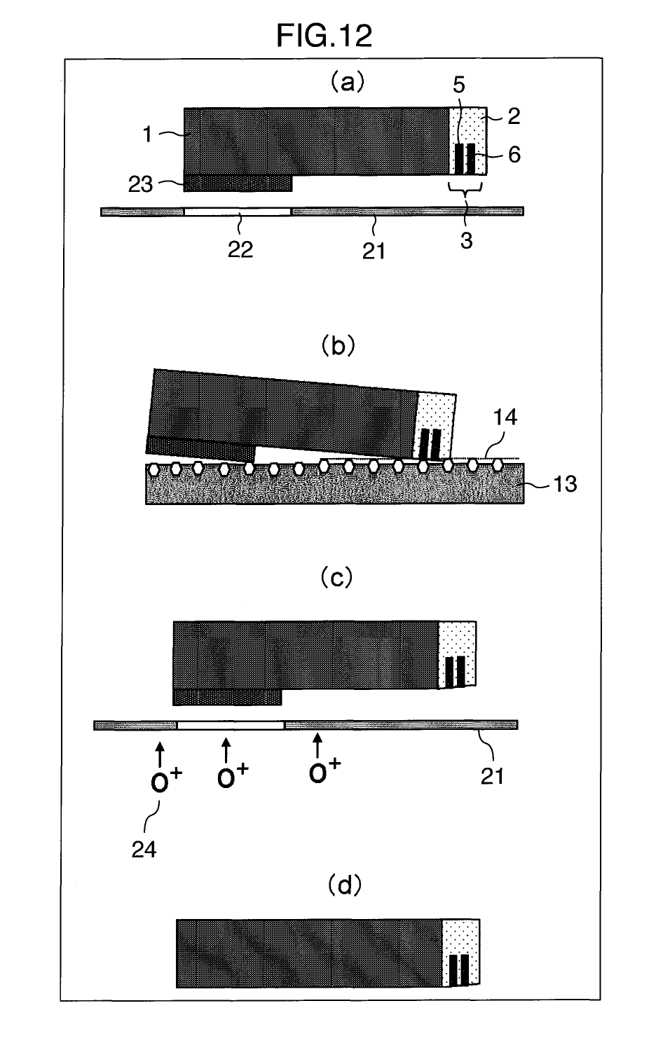

FIG. 11 illustrates the second embodiment. A different point from the first embodiment illustrated in FIG. 4 lies in that without executing the heating process 114 illustrated in FIG. 4, a hard film forming process 214 and a hard film removing process 216 are executed before and after a surface roughness reducing lapping process 215 (in FIG. 4, the surface roughness reducing lapping process 115). These new processes will be described in detail with reference to FIG. 12.

FIG. 12, (a) is a diagram illustrating a process of partially forming a hard film on a ceramic substrate portion constituting an air bearing surface of a magnetic head slider. A numeral 1 indicates a ceramic substrate portion, 2 a magnetic head element portion, 3 an element portion air bearing surface, 5 a magnetic writer element, 6 a magnetic writer element, 21 a hard film forming mask, 22 an opening of the hard film mask, and 23 a hard film. The hard mask used herein is a carbon mask which is preferably made of CVD amorphous carbon or diamond like carbon formed from filtered cathodic arc carbon.

In order to partially form the hard film 23 near at the end of the magnetic head slider opposite to the element portion air bearing surface 3, the hard film forming mask 21 with the opening at the area corresponding to the hard film is disposed. Thereafter, a carbon film having a thickness of 70 nm to 200 nm is formed in the predetermined area by the above-described well-known film forming method. In this embodiment, the hard film 23 was formed to a thickness of 70 nm to 200 nm by using methane plasma gas CVD. An area where the hard film is formed is the area of about 300 μm from a position spaced apart from the edge of the magnetic head element portion by about 500 μm to the opposite end of the ceramic substrate portion 1.

Next, in the surface reducing lapping process 215, lapping was performed by slanting the magnetic head slider (row bar) relative to the lapping plate 13 as illustrated in FIG. 12, (b) in order to reduce the surface roughness of the element portion air bearing surface 3. The surface pressure was set to 0.05 MPa. As seen from FIG. 12, (b) and from the positional relation between the hard film thickness and its area, the row bar inclination angle is about 0.008 degree. Since the Vickers hardness of the CVD carbon film used as the hard film is 4000 or higher which is higher than the Vickers hardness of 2000 of the ceramic substrate material, the abrasive grains will not cut into the hard film 23, and the hard film will not be cut.

On the other hand, since the hardness of the material constituting the element portion is lower than that of ceramics, cut-in by the abrasive grains occur and the lapping progresses. When the end portion of the element portion 2 is lapped by about 3 nm, the area where the abrasive grains on the lapping plate contact the magnetic head slider reaches a boundary area between the ceramic substrate portion 1 and element portion 2, and the abrasive grains start contacting the ceramic substrate portion 1. Since the lapping plate 13 has a lower lapping ability relative to the ceramic substrate portion 1, the position of an abrasive grain blade edge will not enter deeper than the edge of the ceramic substrate portion 1. An element portion protruding beyond a tangent line 14 between the abrasive grain blade edge and the lapping plate is removed without cutting into further. The surface roughness of the element portion air bearing surface is therefore reduced (refer to FIG. 12, (b)).

As illustrated in FIG. 12, (c), after the surface roughness reducing lapping process 215, the mask 21 used in the hard film forming process 214 is disposed at the same position as that in the film forming process, and an oxygen plasma 24 is irradiated from the mask 21 side to remove the hard film 23 in the hard mask removing process 216.

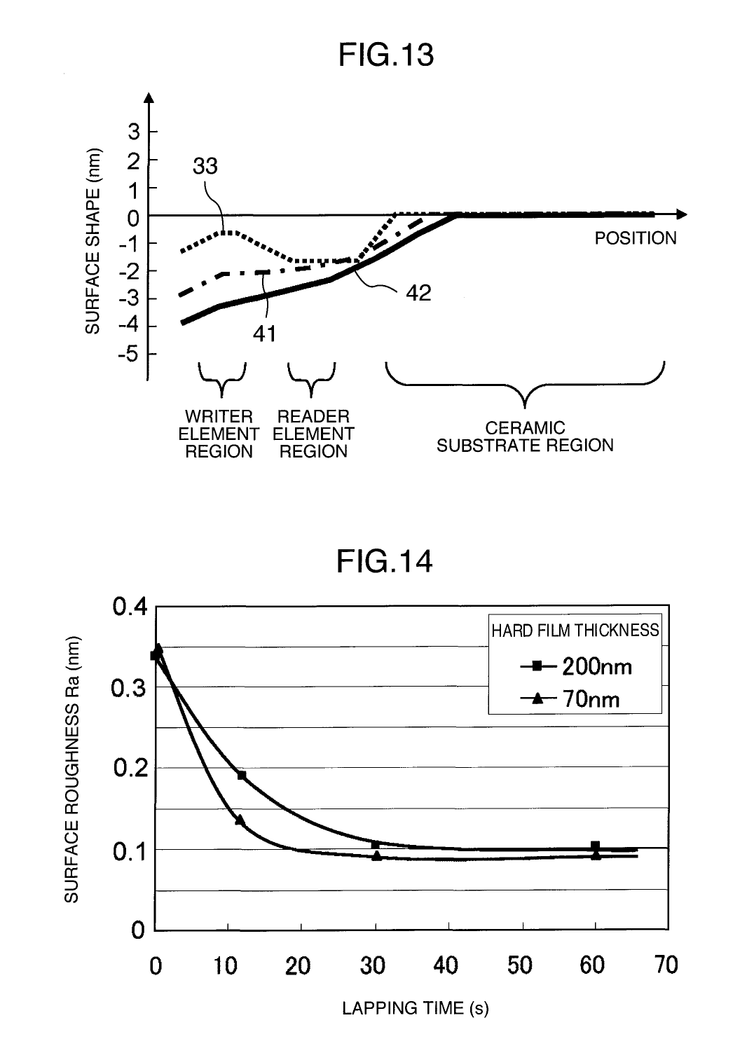

FIG. 12, (d) is a schematic diagram illustrating a cross sectional view of the magnetic head slider after the hard film removing process 216. FIG. 13 illustrates the details of the slider surface shape in this state. In FIG. 13, the line 33 indicates a surface shape at the stage when the element size control lapping process 213 is completed. Lines 41 and 42 indicate the surface shapes respectively at hard film thicknesses of 70 nm and 200 nm.

FIG. 14 illustrates a change in a relationship between lapping time and reader element surface roughness at the hard film thicknesses of 70 and 200 nm. In both cases, similar to the first embodiment, it was possible to realize a lapping surface average roughness of 0.1 nm or smaller after a lapping time of 30 seconds.

The present invention provides a manufacture method capable of improving the surface roughness of the air bearing surface of the magnetic head facing the magnetic disc surface. It is therefore possible to contribute to the performance improvement and the cost reduction of the magnetic head slider having large storage capacity, and also to industrial use largely.

It should be further understood by those skilled in the art that although the foregoing description has been made on embodiments of the invention, the invention is not limited thereto and various changes and modifications may be made without departing from the spirit of the invention and the scope of the appended claims.

1. A manufacture method of a magnetic head slider having an element portion containing a writer element and a reader element disposed on an end portion of a ceramic substrate portion;
wherein a process of lapping an air bearing surface, facing a magnetic disc, of said slider exposing partially said write element and reader element comprises; an element size control lapping process of lapping said writer element and reader element to a predetermined size; and a surface roughness reducing lapping process of reducing a surface roughness of said air bearing surface; and
wherein a lapping rate of said surface roughness reducing lapping process relative to said ceramic substrate portion is 0.001 nm/sec or less.

2. The manufacture method of a magnetic head slider according to claim 1, further comprising a heating process of heating said magnetic head slider in a temperature range of 130° C. or higher and 200° C. or lower for 5 minute or longer between said element size control lapping process and said surface roughness lapping process.

3. The manufacture method of a magnetic head slider according to claim 1, further comprising a hard film forming process of forming a hard film partially on a surface of said ceramic substrate portion between said element size control lapping process and said surface roughness lapping process.

4. The manufacture method of a magnetic head slider according to claim 3, wherein said hard film has a thickness of 50 nm or more and a Vickers hardness of 2000 or higher, and is formed on said ceramic substrate portion at a position spaced apart from an edge of said element portion by 400 nm or more.

5. The manufacture method of a magnetic head slider according to claim 1, wherein in said surface roughness reducing lapping process, an average height of abrasive grains embedded in a lapping plate is 20 nm or lower, and an average abrasive grain density is 0.4 grain/μm² or higher.
